(19) United States
(12) Patent Application Publication
(10) Pub. No.: US 2026/0124998 A1
(43) Pub. Date: May 7, 2026

(54) CONVERTIBLE TAILGATE STORAGE PAD

(71) Applicant: Outlier Campers LLC, Cambridge, MA (US)

(72) Inventor: Ananda Wickramasekera, Cambridge, MA (US)

(21) Appl. No.: 19/173,359

(22) Filed: Apr. 8, 2025

Related U.S. Application Data
(60) Provisional application No. 63/715,702, filed on Nov. 4, 2024.

(51) Int. Cl. B60R 9/10; B60J 11/06; B60R 9/06

(52) U.S. Cl. CPC B60R 9/10; B60J 11/06; B60R 9/06

(57) ABSTRACT

The vehicle padding system is designed to protect a vehicle's tailgate while securely transporting an object, such as a bicycle. It includes a connection pad with a connector, such as MOLLE webbing or a strap, configured to hold objects. A tailgate pad attaches to the vehicle's exterior, and a joint links the connection pad and tailgate pad, allowing the connection pad to flip over the tailgate. The joint may include an anchor for securing to an object's frame, particularly a bicycle. The system may feature two portions of the connection pad that flip over the tailgate independently, providing flexibility and added security. A strap can further secure the padding system to the tailgate, and various configurations of connectors and anchors enhance the system's adaptability and durability. The design allows the joint to cover the tailgate's top, enhancing protection and stability during transport.

### CROSS-REFERENCE TO RELATED APPLICATIONS

This application claims under 35 U.S.C. § 119 (e) the benefit of U.S. Provisional Patent Application No. 63/715,702 filed Nov. 4, 2024, and titled “CONVERTIBLE TAILGATE STORAGE PAD,” the disclosure of which is hereby incorporated herein by reference in its entirety.

### TECHNICAL FIELD

The present disclosure relates to vehicle accessory systems, specifically padding systems for vehicle tailgates designed to protect the vehicle and secure objects, such as bicycles, during transport. The disclosure encompasses mechanisms and structures for affixing and stabilizing items on the tailgate, including connectors, joints, and anchors to ensure secure attachment and protection against movement or damage during transit.

### BACKGROUND

Existing tailgate bike pads (i.e., those that are detachably connected to pickup truck tailgates by use of straps or other attachment mechanisms) are specifically designed to secure one or more bicycles to a pickup's tailgate. They may contain small pockets on an interior side (e.g., a side facing the pickup bed) for storage of bicycle tools or other small items however, these storage pockets do not typically offer a significant amount of storage.

Existing tailgate bike pads are typically thickly padded in the portions that rest against the exterior side, on top of, and on the interior side of pickup tailgates. The padded portion that is on top of a tailgate may prevent the closing of truck cap doors or tonneau covers, including when no bike is attached, because that portion may prevent the truck cap door or tonneau cover end from fitting tightly against the tailgate when closed, which may be necessary for proper closure and/or to make the enclosed bed weather tight. The padded portion on the interior surface of the tailgate which also contains buckles may also make it difficult to load or unload large or heavy items into or from, respectively, the tailgate by creating a surface that is not level with the rest of the pickup tailgate and bed and/or may create an obstruction (e.g., with buckles, etc.) that may cause damage to cargo or to the bike pad itself.

Existing tailgate storage bags (i.e., those that are detachably connected to pickup truck tailgates by use of straps and buckles) are specifically designed to store items that fit inside the bag. They too may contain small exterior pockets but those do not typically offer a significant amount of storage. And they too may contain padding, thick straps, and/or buckles that may interfere with truck cap doors, tonneau cover ends or may obstruct proper loading or unloading of large or heavy objects.

Both tailgate bike pads and tailgate storage bags also have a cumbersome installation method that typically requires a person to push the installation straps up through a small gap at the bottom, exterior side of a tailgate (e.g., between the tailgate bottom and the bumper) with one hand, while holding the tailgate open at about a 45 degree angle with the other hand, then somehow grabbing the straps from above the gap, on the interior side of the pickup bed, before they fall back through-a challenging task with most tailgates, but especially so for large and heavy ones. For frequent removal and installation of most tailgate bike pads and tailgate storage bags this will get tiresome.

The convertible tailgate storage pad disclosure described herein combines the carrying capacity of tailgate bike pads with the exterior storage capacity of tailgate storage bags (by allowing attachment of a bag to the pad); adds additional storage capacity by allowing attachment of multiple bags; adds even more storage capacity beyond both types of existing products by use of standard, MOLLE-style webbing compatible with commonly available MOLLE storage bags, cases, and accessories, or some non-MOLLE-compatible bags, cases and items may be secured directly to the MOLLE straps with other attachment mechanisms, allowing more than just tailgate trash bags to be carried on the back of a tailgate; has an attachment method that may not interfere with most truck cap doors and tonneau covers and may not cause an obstruction or create an uneven surface for loading/unloading of large or heavy cargo; installs easily and quickly; and can be configured to carry only bicycles partially inside the pickup bed, configured to only store items on the exterior side of the tailgate, or half or a portion can be configured to carry bicycles while the other half or portion can be configured for exterior storage.

The convertible tailgate storage pad consists of a pad (e.g., a foam pad, foam batting, or loose foam enclosed by vinyl or other waterproof or water-resistant fabric) which is foldable into two, three, or more sections with: straps that go around a pickup's tailgate that are detachably connected by buckles on a first padded section (e.g., on the exterior side of the tailgate) to attach the pad to the tailgate; openable loops (e.g., straps with hook and loop fasteners or another attachment mechanism) to secure bicycles on a small, second padded section; and MOLLE-style rows and/or columns of webbing to attach storage bags, cases, or other items directly to a third padded section; where the second padded section connects the first padded section to the third padded section and where the third padded section is also detachably connected to the first padded section along the free ends of both sections by straps and buckles or another attachment mechanism; and where the second and third padded sections may be further divided in half or into two or more portions so that either all or a portion of the convertible tailgate storage pad may be configured to store one or more exterior items or all or a portion of it may be converted to store one or more bicycles.

When not in use for storage of bicycles, the convertible tailgate storage pad may only contain thin straps over the top and interior sides of a pickup's tailgate, which may allow a truck cap rear door or tonneau cover end (if a truck is so equipped) to function properly and may not interfere with the loading or unloading of objects.

### SUMMARY OF THE DISCLOSURE

Described herein is a convertible tailgate storage pad that can be configured to store items on an exterior side of a pickup truck tailgate or can be configured to transport bicycles partially inside the bed of a pickup truck; Or a portion of it may be configured for exterior storage and a portion may be configured for bicycle transportation. The convertible tailgate storage pad may consist of soft, padded material that is foldable (e.g., like a book) into two, three, or more sections, where a first padded section may contain non-abrasive material (e.g., like felt) on its inward facing side which may rest against the exterior side of a pickup truck tailgate and may be attachable (e.g., by straps and/or buckles or by another mechanism) to the tailgate; a second padded section may be a small section that joins a first padded section with a third padded section and may contain openable loops (e.g., formed by straps with hook and loop fasteners or another mechanism) on its bottom or inward facing side, when the tailgate storage pad is configured for exterior storage, and on its top or outward facing side to secure bicycles, when the tailgate storage pad is configured to transport bicycles; and a third padded section, joined to the second padded section on one end, may contain MOLLE-style rows and/or columns of webbing on its outward facing side to attach and store bags, trash bags, cases, gear, equipment, and other items (e.g., as the MOLLE attachment system is designed for); and where the third padded section is detachably connected to the first padded section (e.g., by straps and/or buckles and/or by another mechanism) so that it may be partially detached from the first padded section to allow it to pivot away from the tailgate to allow the tailgate to open or to allow the second and third padded sections to be flipped over the tailgate so that the bicycle carrying loops on the second padded section will be on top of the tailgate and the third padded section will provide padding on an interior side of the tailgate to convert the convertible tailgate storage pad for transportation of bicycles.

When the convertible tailgate storage pad is configured for exterior storage, it may only contain straps along the top and interior sides of the pickup truck tailgate to which it is attached, which may be sufficiently thin enough to not cause an obstruction to loading or unloading cargo to or from, respectively, the pickup bed when the tailgate is opened or lowered, and to allow a truck cap rear door or hard or soft tonneau cover, if a truck is so equipped, to close properly over the tailgate when the tailgate is raised or closed.

The convertible tailgate storage pad disclosure provided herein can be configured to store items inside one or more bags attached to it or store items directly attached to it on an exterior side of a pickup truck tailgate to which it may be attached, or all or a portion of the convertible tailgate storage pad may be converted to store, carry, or transport one or more bicycles partially inside a pickup truck to which it may be attached, with each of the bicycle's down tubes or frames attached to the pad such that each bicycle may straddle the pickup's tailgate, with the majority of each bicycle in the bed of the pickup while each of their front tires is on the exterior side of the tailgate.

The convertible tailgate storage pad may be comprised of cushioning material such as loose foam, foam batting, foam pads, or other cushioning material that is enclosed by a soft waterproof or water-resistant fabric, such as vinyl or a similar material, to prevent stored items or bicycles from damaging the pickup truck tailgate to which it may be attached, to prevent stored items or bicycles from damaging each other, and to prevent the tailgate from damaging stored items or bicycles. The tailgate storage pad may be divided and/or foldable into two, three, or more padded sections where a first padded section may be joined to a smaller second padded section which, in turn, may be joined to a third padded section, such that the three padded sections are in series, when unfolded, with the smaller second padded section joining the first and third padded sections, like the spine of a book joins its back and front covers; where the three padded sections may be foldable, like a book; and where the unattached ends of the first and third padded sections may be detachably connected to each other, like a hardcover book with a latch on it may latch the front and back covers to each other to prevent opening. Each padded section may be formed by having a foam pad that is smaller than or fits into the section it's located in and where the enclosing fabric may be continuous across all sections and may be stitched around and between the foam pads of adjoining sections.

This configuration may cause the stitched areas between adjoined sections to function like hinges to allow folding or unfolding of the sections of the convertible tailgate storage pad; Or if the tailgate storage pad consists of one continuous piece of foam pad, foam batting, or loose foam enclosed by a waterproof or water-resistant fabric, it may contain stitching through the foam to divide the tailgate storage pad into sections, where the dividing stitches act like hinges or folds; Or the convertible tailgate storage pad may contain one piece of continuous foam, foam batting, or loose foam enclosed by a waterproof or water-resistant fabric with little or no stitching between sections or no sectioning of the tailgate pad but may still be foldable into two, three, or more sections, if it's thin enough to fold.

A first padded section of the convertible tailgate storage pad may further contain nylon straps, or similar strapping material, that, together with buckles, hook and loop fasteners, snaps, and/or other attachment mechanisms may detachably connect the convertible tailgate storage pad to a tailgate of a pickup truck. The first padded section may further contain a soft, non-abrasive fabric material such as felt on the surface that touches the exterior side of the tailgate to prevent or minimize scratching of the painted tailgate surface. With the first padded section on the exterior side of a pickup tailgate, the nylon straps, which may be fixed on one end to or near the top of the first padded section, or elsewhere on the first padded section, may be passed over the top of the tailgate, down the interior side of the tailgate, and pushed or allowed to fall through a gap between the bottom of a partially open tailgate and the bed of the truck; The straps may then be pulled up from the bottom of the exterior side of the tailgate and buckled to buckles fixed to the outward facing side (e.g., the side facing away from the tailgate) of the first padded section, then cinched, if necessary (or attached by another attachment mechanism or combination of attachment mechanisms), firmly attaching the convertible tailgate storage pad to the tailgate.

Additional straps and/or buckles and/or other attachment mechanisms may be fixed to a bottom end of the first padded section, or elsewhere on the first padded section, that may detachably connect to corresponding straps and/or buckles on a third padded section to latch the first and third padded sections together to configure the convertible tailgate storage pad for exterior storage, as further described below. Small nylon (or other fabric) loops may also be present on the portion of the securing straps present on the interior side of the tailgate that may allow a third padded section to be detachably connected to straps of the first padded section on the inside of a pickup bed to which the convertible tailgate storage pad is attached to configure it for bicycle transportation, as further described below.

The small loops may also provide a closed loop to pass a cable lock or padlock to secure the convertible tailgate storage pad to a portion of the pickup truck tailgate or bed to prevent theft of the pad (e.g., if the tailgate is openable without a key or if the gap between the pickup truck's tailgate and bed, at the bottom, is sufficiently wide enough for the straps of the convertible tailgate storage pad to be unbuckled and pulled up through the gap without opening the tailgate, freeing the convertible tailgate storage pad). All or most buckles or other connecting mechanisms, which may be made of plastic, metal, or another rigid material and/or may be thicker than the straps they're attached to may be on the outward facing side of the first padded section and only the straps and any small loops stitched to them, which may be made of nylon or made of other fabric material, will run along the top and interior sides of the tailgate.

The securing strap material along the top and interior sides of the tailgate may be sufficiently thin and/or soft enough to not cause an obstruction to loading or unloading cargo to or from, respectively, the bed of the pickup; may not be damaged by or cause damage to the cargo; and may not obstruct proper closing of a truck cap, topper, or camper shell rear door or hard or soft tonneau cover, if a truck to which it is attached is so equipped. Along its top edge, the first padded section will be joined to a second padded section, which in turn will be joined to a third padded section, such that attaching the first padded section to a pickup truck tailgate detachably connects the whole convertible tailgate storage pad to the tailgate.

A smaller, second padded section of the convertible tailgate storage pad may be joined on one end to a first padded section and joined on another end to a third padded section, as mentioned. It may contain several (e.g., one, two, three, four, five, six, seven, or more) nylon straps that may be passed through a loop (e.g., a plastic ring or nylon loop) then securely fastened back onto itself by hook and loop fasteners, slide buckles, or by another attachment mechanism, or combination of attachment mechanisms, forming an openable loop. These straps may be used to firmly secure one or more bicycles to the convertible tailgate storage pad. The straps may be present on the bottom or inner side of the second padded section when the pads are folded against each other (e.g., like the pages of a book may be present on the inner side of the book's spine, when it's closed). In this configuration the bicycle-securing straps will be concealed between the padded sections and not in use.

When the convertible tailgate storage pad is first unfolded then folded backward, so that the second and third padded sections may be rotated at almost a 360 degree angle relative to the first padded section, so that the second padded section is now resting on top of the tailgate and the third padded section is now resting against the interior side of the tailgate, the bicycle-securing straps will now be present on the upper or outer side of the second padded section, like a book with its covers folded backward will have the pages on the now upper or outer side of the spine.

With the bicycle-securing straps positioned on the top of a pickup truck tailgate to which the convertible tailgate storage pad may be attached, they each may be able to firmly and securely hold a bicycle by strapping the bicycle's down tube (or other part of the frame) through one of the bicycle-securing straps, keeping the bicycle upright, straddling the tailgate, with its front tire and fork on the exterior side of the tailgate, while the rest of the bicycle sits above the tailgate and/or inside the bed of the pickup truck. This configuration will allow one or more bicycles to be transported using the bed of a pickup truck, protecting the truck from the bicycles, protecting the bicycles from the truck, and protecting the bicycles from one another, if more than one is attached. In this configuration, the convertible tailgate storage pad is converted for bicycle transportation, and if the pickup truck is equipped with a truck cap, topper, or camper shell, or equipped with a hard or soft tonneau cover, the cap, topper, or shell's rear door or tonneau cover's rear end may need to be left open because one or more bicycles, if present, will prevent the doors or ends from closing. If no bicycle is present, the convertible tailgate storage pad's padded section on top of the tailgate may still be too thick to allow proper closing of a rear door or cover end.

If the convertible tailgate storage pad is not currently transporting one or more bicycles, however, it may be quickly and easily converted for exterior storage, as further described below, where no padded sections (i.e., only straps) may be present on the top of the tailgate, allowing any rear doors or cover ends to be properly closed. The second padded section may further be divided into two or more sub-sections that may be joined to corresponding sub-sections of a third padded section so that only a portion or portions of the convertible tailgate storage pad may be converted for bicycle transportation while another portion or portions may remain configured for exterior storage, as further described below.

A third padded section of the convertible tailgate storage pad may be joined on one end to the second padded section and may be detachably connected on its free end to the first padded section, as mentioned. The third padded section may contain nylon straps, or similar strapping material, that may form overlapping rows and/or columns of webbing to create a MOLLE-style attachment system to which MOLLE-compatible storage bags, cases, and accessories may be detachably connected by interweaving the straps on the bags, cases, or accessories between the webbing on the pad and the webbing on the bag to form a tight, secure fit between the bag and pad; Or certain items, such as fishing poles, recovery traction boards, fire extinguishers, flash lights, tools, other gear and items, or other non-MOLLE bags and cases may secured directly to the MOLLE webbing on the pad by use of straps, buckles, hook and loop fasteners, clips, carabiners, zip ties, rope, string, or other attachment mechanisms and methods or a combination of mechanisms and methods.

The third padded section may also contain straps and/or buckles and/or other attachment mechanisms that may detachably connect to corresponding straps and/or buckles and/or other attachment mechanisms on the first padded section, allowing the first and third padded sections to be detachably connected to each other on the exterior side of a pickup truck tailgate, to configure the convertible tailgate storage pad for exterior storage. When the convertible tailgate storage pad is configured for exterior storage the overlapping rows and/or columns of webbing will be on the exterior facing side (i.e., the side facing away from the tailgate) of the third padded section.

This will allow items to be stored on the exterior facing side of the tailgate. Some of these stored items may be too bulky to allow the tailgate to fully open, when attached, because the tailgate may only have a small amount of clearance above the rear bumper of the pickup truck, when it's opened and partially or fully lowered. To allow unobstructed movement of the tailgate, if necessary, with or without items stored on the exterior side of the third padded section of the convertible tailgate storage pad, the third padded section may be partially and temporarily detached from the first padded section (e.g., unbuckled or unlatched) to allow the third padded section to pivot away from the first padded section and tailgate, as the tailgate is in transition of being opened or closed or when fully open.

This will also allow stored items on the third padded section, if present, to be kept upright, while the tailgate is in transition of being opened or closed or when fully open. This will prevent or minimize leaks from containers with liquid (e.g., trash bags with liquid waste or water containers) and it may also keep containers with access from the top (e.g., top lids) still easily accessible with the tailgate up or down. The buckles or other attachment mechanisms used to secure the third padded section to the first padded section may also be unbuckled or unlatched to allow the second and third padded sections, which may be joined to each other, to be flipped over the pickup truck tailgate (e.g., rotated at an almost 360-degree angle relative to the first padded section) to convert the convertible tailgate storage pad for bicycle transportation.

The third padded section may further contain small straps with hook and loop fasteners and/or other attachment mechanisms on the side opposite of the MOLLE-style webbing (e.g., on the inward facing side or side of the pad facing the tailgate when the convertible tailgate storage pad is configured for exterior storage or on the side of the pad facing the interior of the bed when the convertible tailgate storage pad is converted for bicycle transportation) that may correspond to loops and/or other attachment mechanisms on the tailgate securing straps of the first padded section on the interior side of a pickup truck tailgate to which the convertible tailgate storage pad is attached. When the third padded section (along with the second padded section) is flipped over to convert the convertible tailgate storage pad for bicycle transportation, the small straps with hook and loop fasteners (or other attachment mechanisms) may be passed through the corresponding small loops (or other corresponding attachment mechanisms) on the tailgate-securing straps of the first padded section on the interior side of the tailgate. This will allow the third padded section and, with it, the second padded section to be firmly secured to and over the tailgate (e.g., so that they're not loose during transit).

In this configuration, with any stored items secured to the webbing on the third padded section removed, if necessary, and the second padded section now resting on top of the tailgate and the third padded section now resting against the interior side of the tailgate (e.g., the side with the overlapping rows and/or columns of webbing will now be facing the interior side of the tailgate and the small hook and loop straps on the opposite side will be facing the interior of the bed), a bicycle may be secured to each of the bicycle-securing straps on the second padded section, as mentioned above.

\The third padded section may be divided into two or more sub-sections that are joined to corresponding sub-sections of the second padded section to allow a portion or portions of the convertible tailgate storage pad to be converted for bicycle storage while another portion or portions remains configured for exterior storage, as previously mentioned. If the second and third padded sections are each further divided as described, then only those desired portions may be unbuckled or unlatched from the undivided first padded section and flipped over the tailgate to be secured to the interior portion of the straps (e.g., the small loops on the interior portion of the tailgate securing straps) of the first padded section. With a portion or portions of the convertible tailgate storage pad configured for bicycle transportation while another portion or portions remain configured for exterior storage, the convertible tailgate storage pad may be able to transport one or more bicycles as well as contain items stored on its exterior side.

In some embodiments, a vehicle padding system comprises a connection pad with a connector configured to secure an object to the vehicle padding system, a tailgate pad designed to attach to the exterior side of a vehicle's tailgate, and a joint linking the connection pad and the tailgate pad. The connection pad is configured to flip over the tailgate via the joint. The connector may include MOLLE webbing, a strap with a fastener, or a combination of both. The joint may include an anchor configured to attach to an object's frame and may surround a portion of a bicycle frame. The connection pad may further include a first portion and a second portion, each capable of flipping over the tailgate via separate portions of the joint. The vehicle padding system may also include a strap to secure the system to the tailgate, and when the connection pad flips, the joint may cover the top of the tailgate.

In some embodiments, the vehicle padding system comprises a connection pad, a tailgate pad attached to a vehicle's tailgate, and a joint between them with an anchor designed to attach to a bicycle frame, allowing the connection pad to flip over the tailgate and cover the top. The connector may include MOLLE webbing, a strap with a fastener, or both. Additionally, the connection pad may feature dual portions, each independently flippable over the tailgate via respective joint sections, and a strap may attach the system to the tailgate.

In some embodiments, a vehicle padding system comprises a connection pad with a connector for securing an object, dual portions, a tailgate pad, and a joint between the connection pad and tailgate pad. The first and second portions of the connection pad are each configured to flip over the tailgate via distinct sections of the joint. The joint may include an anchor to secure an object's frame and may surround a portion of a bicycle frame. Additionally, the connector may include MOLLE webbing, a strap with a fastener, or both, and the system may have a strap to secure it to the tailgate. When either portion of the connection pad flips over the tailgate, the joint portion may cover the top of the tailgate.

### BRIEF DESCRIPTION OF DRAWINGS

FIG. 1 shows a front perspective view of an exemplary convertible tailgate storage pad configured for exterior storage attached to an exemplary pickup truck, according to some embodiments of the present disclosure;

FIG. 2 shows a close-up perspective view of the main sections of an exemplary convertible tailgate storage pad while configured for exterior storage attached to an exemplary pickup truck tailgate, according to some embodiments of the present disclosure;

FIG. 3 shows a rear perspective view of an exemplary convertible tailgate storage pad configured for exterior storage attached to an exemplary pickup truck tailgate, according to some embodiments of the present disclosure;

FIG. 4 shows a front perspective view of an exemplary convertible tailgate storage pad configured for exterior storage attached to an exemplary pickup truck with its tailgate open, according to some embodiments of the present disclosure;

FIG. 5 shows a bottom, rear perspective view of an exemplary convertible tailgate storage pad configured for exterior storage attached to an exemplary pickup truck with its tailgate open, according to some embodiments of the present disclosure;

FIG. 6 shows a front perspective view of an exemplary convertible tailgate storage pad attached to an exemplary pickup truck in transition between an exterior storage configuration and a bicycle transportation configuration, according to some embodiments of the present disclosure;

FIG. 7 shows a front perspective view of an exemplary convertible tailgate storage pad configured for bicycle transportation attached to an exemplary pickup truck, according to some embodiments of the present disclosure;

FIG. 8 shows a rear perspective view of an exemplary convertible tailgate storage pad configured for bicycle transportation attached to an exemplary pickup truck, according to some embodiments of the present disclosure;

FIG. 9 shows a front perspective view of an exemplary convertible tailgate storage pad attached to an exemplary pickup truck with a portion of it in transition between an exterior storage configuration and a bicycle transportation configuration, according to some embodiments of the present disclosure;

FIG. 10 shows a front perspective view of an exemplary convertible tailgate storage pad with a portion of it configured for bicycle transportation and a portion of it configured for exterior storage attached to an exemplary pickup truck, according to some embodiments of the present disclosure;

FIG. 11 shows a rear perspective view of an exemplary convertible tailgate storage pad with a portion of it configured for bicycle transportation and a portion of it configured for exterior storage attached to an exemplary pickup truck, according to some embodiments of the present disclosure;

FIG. 12 shows an exemplary MOLLE bag in transition of being attached and another exemplary MOLLE bag already attached to an exemplary convertible tailgate storage pad which is attached to an exemplary pickup truck, according to some embodiments of the present disclosure;

FIG. 13 shows a front perspective view of two exemplary MOLLE bags attached to an exemplary convertible tailgate storage pad which is attached to an exemplary pickup truck, according to some embodiments of the present disclosure;

FIG. 14 shows a front perspective view of two exemplary MOLLE bags attached to an exemplary convertible tailgate storage pad which is attached to an exemplary pickup truck with its tailgate open, according to some embodiments of the present disclosure;

FIG. 15 shows a front perspective view of four exemplary bicycles attached to an exemplary convertible tailgate storage pad which is attached to an exemplary pickup truck, according to some embodiments of the present disclosure;

FIG. 16 shows a rear perspective view of four exemplary bicycles attached to an exemplary convertible tailgate storage pad which is attached to an exemplary pickup truck, according to some embodiments of the present disclosure;

FIG. 17 shows a front perspective view of two exemplary bicycles and one exemplary MOLLE bag attached to an exemplary convertible tailgate storage pad which is attached to an exemplary pickup truck, according to some embodiments of the present disclosure; and

FIG. 18 shows a rear perspective view of two exemplary bicycles and one exemplary MOLLE bag attached to an exemplary convertible tailgate storage pad which is attached to an exemplary pickup truck, according to some embodiments of the present disclosure.

While the disclosure is susceptible to various modifications and alternative forms, specific embodiments thereof have been shown by way of example in the drawings and are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

### DETAILED DESCRIPTION OF SPECIFIC EMBODIMENTS

Described herein are devices, components, assemblies, systems, methods, etc. for convertible tailgate storage pads. The description and accompanying figures, which describe and show certain embodiments, are made to demonstrate, in a non-limiting manner, several possible configurations of convertible tailgate storage pads, apparatuses, components, assemblies, systems, etc. and various methods of using them according to various aspects and features of the present disclosure. Accordingly, the disclosure is not limited to the specific embodiments described. Rather, the inventive principles associated with the embodiments described herein, including with respect to the apparatuses, devices, components, assemblies, systems, methods, etc. described herein, may be applied in a variety of ways, including to other types of apparatuses, devices, components, assemblies, systems, methods, etc. General and specific apparatuses, devices, components, assemblies, systems, methods, etc. are described herein sufficiently to enable one to develop a variety of implementations/applications without undue experimentation. In the development of particular applications, numerous implementation-specific decisions will be made to achieve the design-specific goals, which will vary from one implementation/application to another. It will be appreciated that, having access to this disclosure and reading this disclosure, such a development effort would be a routine undertaking for persons of ordinary skill in the art.

This document does not intend to distinguish between components that differ in name but not function. In the following discussion and in the claims, the terms “including,” “includes,” “comprising,” “have,” and “has” are used in an open-ended fashion, and thus should be interpreted to mean “including, but not limited to.” The word “or” is used in the inclusive sense (i.e., “and/or”) unless a specific use to the contrary is explicitly stated.

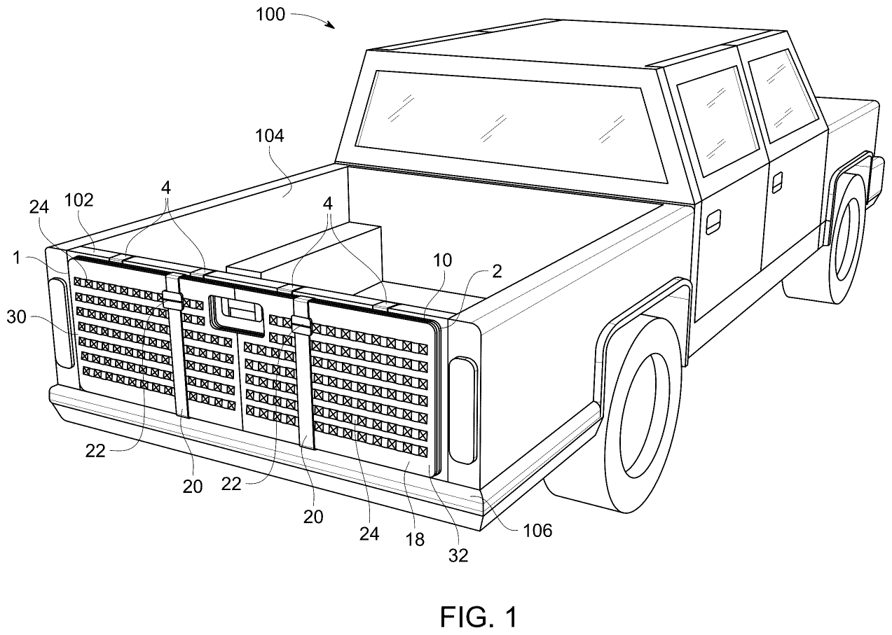

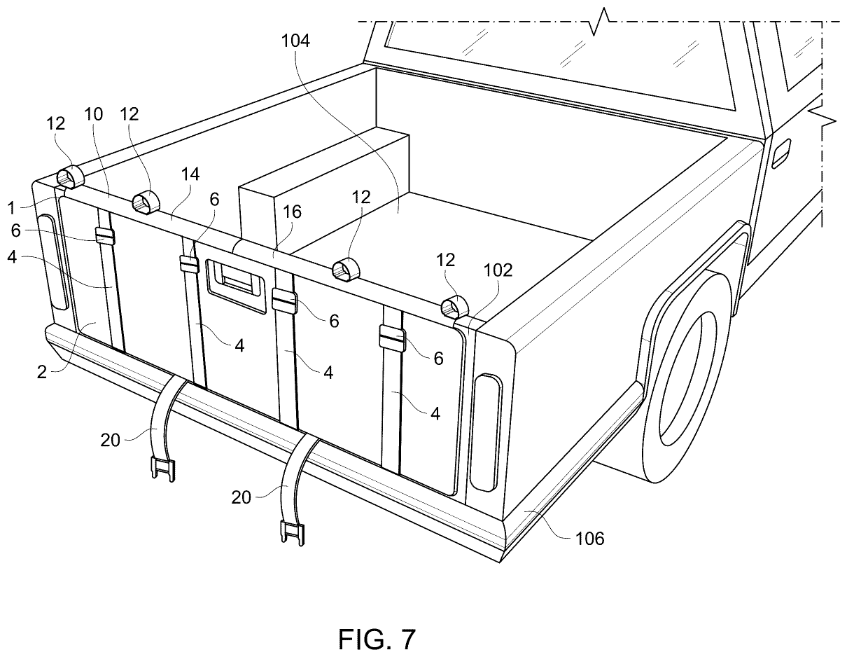

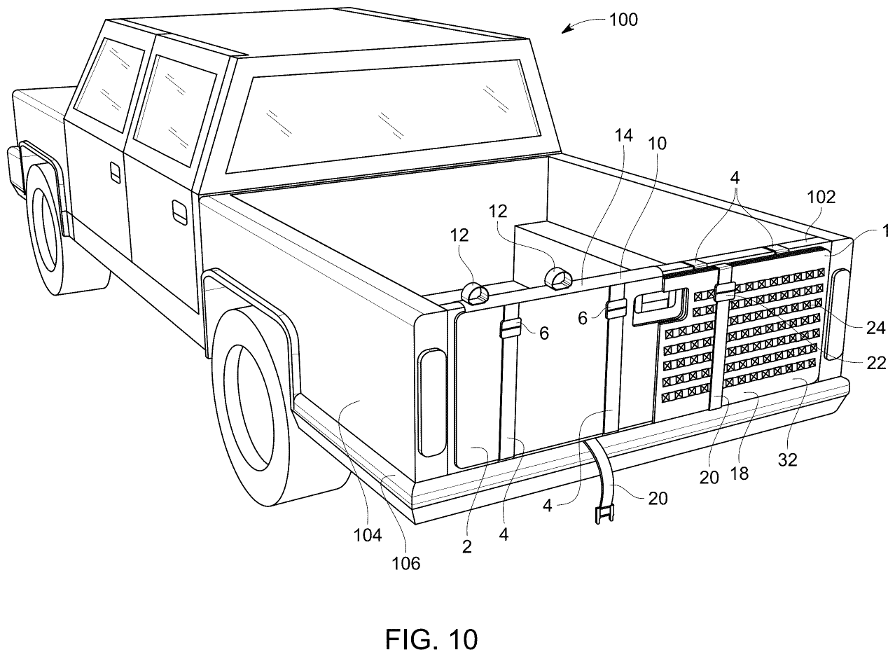

Convertible tailgate storage pad 1 may be configured as a soft storage apparatus connectable to a pickup truck tailgate that may may be configured to provide storage on an exterior side, as shown in FIGS. 1, 4, 13, and 14; or may be configured to provide bicycle storage or transportation on upper and interior sides, as shown in FIGS. 7, 8, 15, and 16; or a portion of the exterior side may be configured for exterior storage while a portion of the upper and interior sides may be configured for bicycle storage or transportation, as shown in FIGS. 10, 11, 17, and 18.

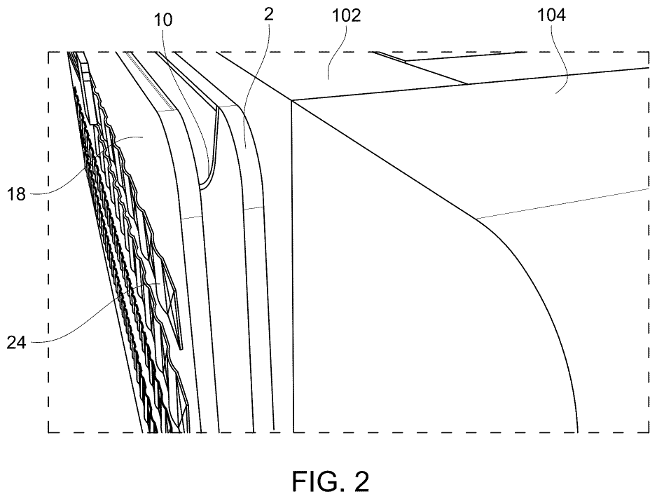

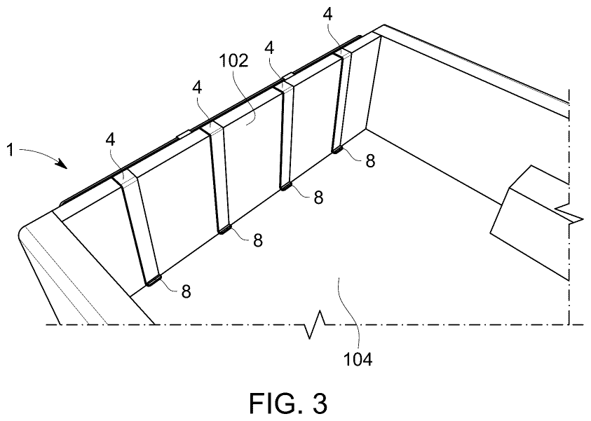

Convertible tailgate storage pad 1 may be comprised of cushioning material such as loose foam, foam batting, foam pads, or other cushioning material that may be enclosed by a soft waterproof or water-resistant fabric, such as vinyl or a similar material. As shown more closely in FIG. 2, convertible tailgate storage pad 1 may be divided into sections 2, 10, and 18, where section 2, which may be a 1^{st} padded section, may be joined to section 10, which may be a 2^{nd} padded section, which, in turn, may be joined to section 18, which may be a 3^{rd} padded section, such that the sections 2, 10, and 18 are in series, when unfolded, with section 10 joining section 2 to section 18; where sections 2, 10, and 18 may be foldable; where, as shown in FIG. 1, the unattached end of section 2 may be detachably connected to the unattached end of section 18 by straps 20 and buckles 22; and where, as shown in FIGS. 1 and 3, convertible tailgate storage pad 1 may be detachably fixed by straps 4 and buckles 6 (buckles 6 are shown in FIG. 7) to tailgate 102 of truck 100. Sections 2, 10, and 18 may each be formed by having a foam pad that is smaller than or fits each respective section and where the enclosing fabric may be continuous across all sections and may be stitched around and between the foam pads of adjoining sections (i.e., around and between sections 2 and 10, and around and between sections 10 and 18).

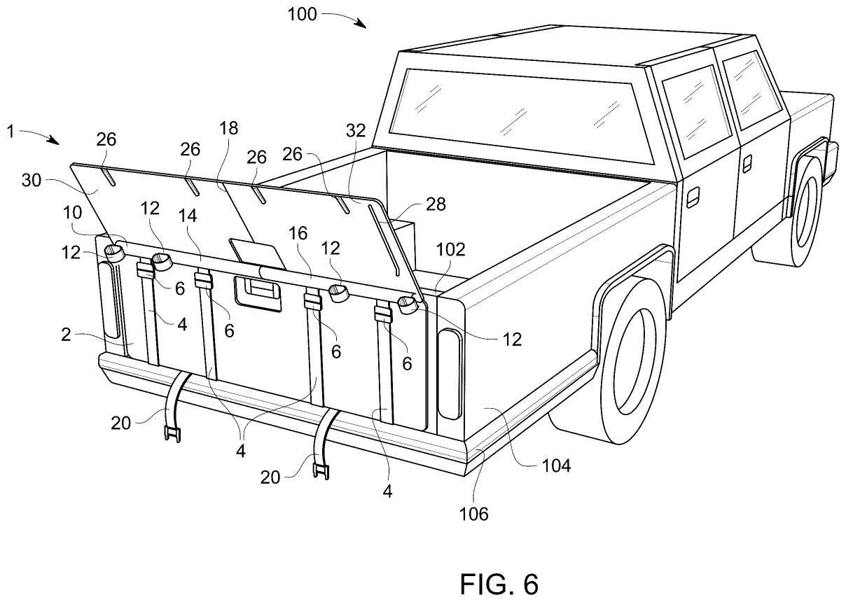

This configuration may cause the stitched areas between sections 2, 10, and 18 to function like hinges to allow folding or unfolding of the sections of convertible tailgate storage pad 1, as shown in transition in FIG. 6; Or if convertible tailgate storage pad 1 consists of one continuous piece of foam pad, foam batting, or loose foam enclosed by waterproof or water-resistant fabric, it may contain stitching through the foam to divide convertible tailgate storage pad 1 into sections 2, 10, and 18, where the dividing stitches act like hinges or folds; Or convertible tailgate storage pad 1 may contain one piece of continuous foam, foam batting, or loose foam enclosed by a waterproof or water-resistant fabric with little or no stitching to form sections, but may still be foldable into sections 2, 10, and 18.

Section 2, which may be a 1^{st} padded section of convertible tailgate storage pad 1, may further contain straps 4, which may be made of nylon or similar strapping material, each of which may be joined by or to one of buckles 6, which may be buckles, hook and loop fasteners, snaps, and/or other attachment mechanisms to detachably connect convertible tailgate storage pad 1 to tailgate 102 of pickup truck 100, which may be an exemplary pickup truck with a tailgate, as shown in FIGS. 1, 3, and 7. Section 2 may further contain a soft, non-abrasive fabric material such as felt on the surface that touches the exterior side of tailgate 102 to prevent or minimize scratching of tailgate 102.

With section 2 on an exterior side of a tailgate 102, straps 4, each of which may be fixed at or near a top edge of section 2, may be passed over a top side or end of tailgate 102, then down an interior side of tailgate 102, then pushed through a gap between the bottom of (a partially open) tailgate 102 and bed 104 of truck 100; each of straps 4 may then be pulled up from the bottom of the exterior side of tailgate 102 and joined to one of buckles 6, fixed to the outward facing side (e.g., the side facing away from tailgate 102), of section 2, and lastly cinched, if necessary, (or attached by another attachment mechanism or combination of attachment mechanisms) firmly attaching convertible tailgate storage pad 1 to tailgate 102 of truck 100, as shown in a completed installation in FIGS. 1, 3, and 7. Each of straps 20, which may be fixed to or near a bottom end of section 2, may detachably connect to one of buckles 22, each of which may consist of buckles and/or straps (or other attachment mechanisms) on an exterior side of section 18 to detachably connect section 2 to section 18 to configure convertible tailgate storage pad 1 for exterior storage, as shown in FIG. 1.

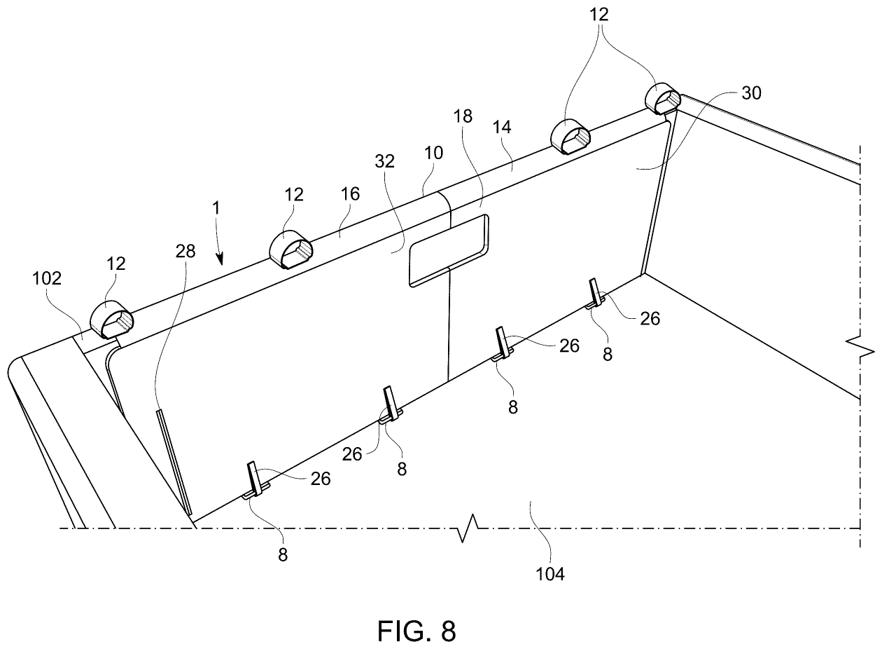

Loops 8, which may be small nylon (or other fabric) loops may also be present on a portion of each of straps 4 present on the side of tailgate 102 that faces the interior of bed 104, as shown in FIG. 3, which may allow section 18 to be detachably connected inside bed 104 to section 2 to configure convertible tailgate storage pad 1 for bicycle transportation, as shown before attachment in FIG. 3, and shown after attachment in FIG. 8.

Each of loops 8 may also provide a closed loop to pass a cable lock or padlock to secure convertible tailgate storage pad 1 to a portion of tailgate 102 or bed 104 to prevent theft of the pad (e.g., if tailgate 102 is openable without a key or if the gap between tailgate 102 and bed 104, at the bottom, of a closed tailgate is sufficiently wide enough for straps 4 of convertible tailgate storage pad 1 to each be detached from one of buckles 6 and easily pulled up through the gap, freeing convertible tailgate storage pad 1). All or most of buckles 6 or other connecting mechanisms, which may be made of plastic, metal, or another rigid material and/or may be thicker than straps 4, the straps to which they're attached, may be on an outward facing side of section 2 such that only straps 4 each of which contains one of loops 8, and where both may be made of nylon or made of other fabric material, may run along the top and interior sides of tailgate 102, as shown in FIGS. 1, 3, and 4.

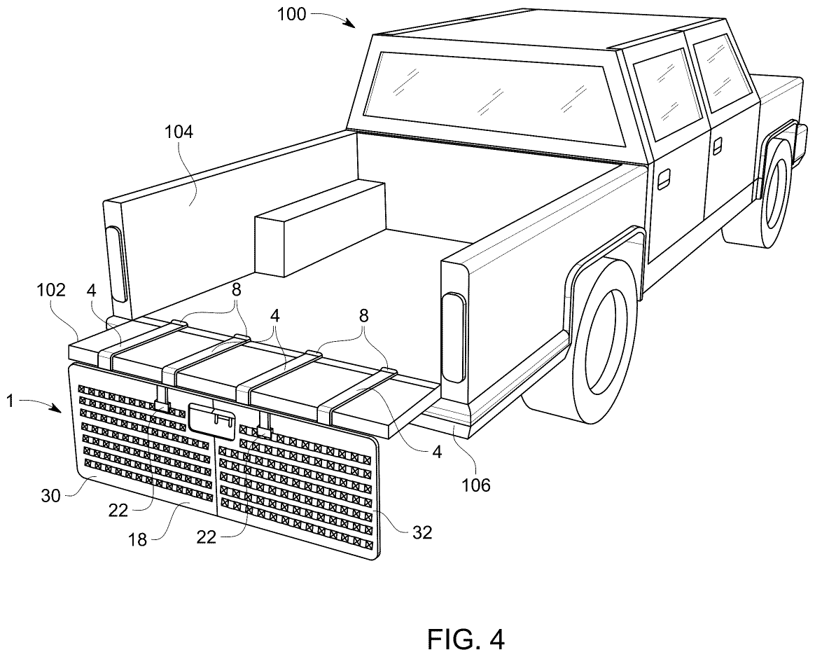

When tailgate 102 of truck 100 is opened or lowered, as shown in FIG. 4, straps 4, each of which contains one of loops 8 along a top side of tailgate 102 (e.g., a top side of tailgate 102 when it is opened or lowered) may be sufficiently thin and/or soft enough to not cause an obstruction when loading cargo onto or unloading cargo off bed 104 and may not be damaged by or cause damage to the cargo. When tailgate 102 is closed or raised, as shown in FIGS. 1 and 3, that portion of straps 4 that may be on or near the top side or end of tailgate 102 (e.g., a top side or end of tailgate 102 when it is closed or raised) may be thin enough to not obstruct proper closing of a truck cap, topper, or camper shell rear door or hard or soft tonneau cover, if truck 100 is so equipped. Along its top edge, section 2 may be joined to section 10, which in turn may be joined to a section 18, such that attaching section 2 to tailgate 102 of truck 100 detachably fixes all sections (e.g., sections 2, 10, and 18) and their respective components of convertible tailgate storage pad 1 to tailgate 102 of truck 100, as shown in FIG. 1.

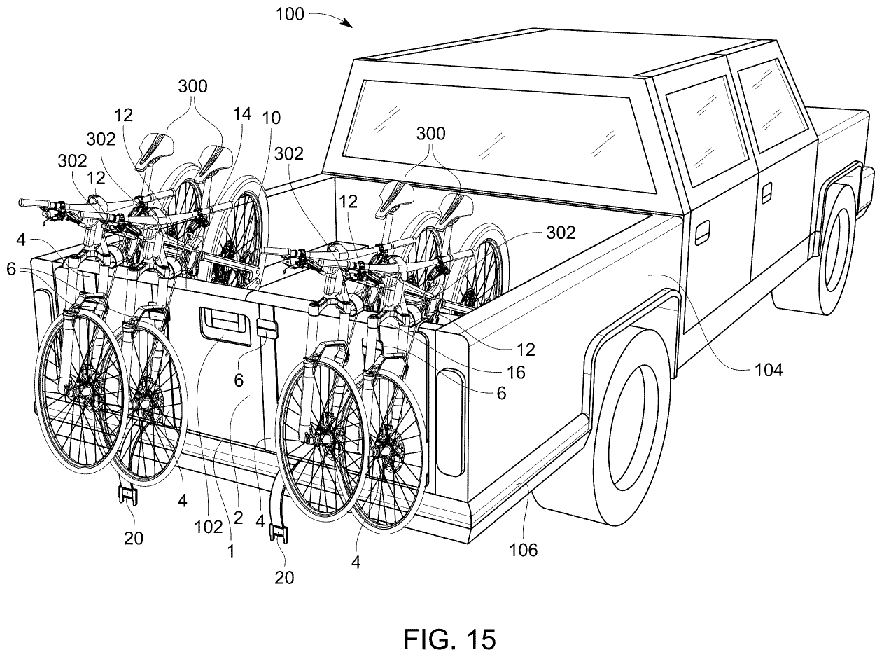

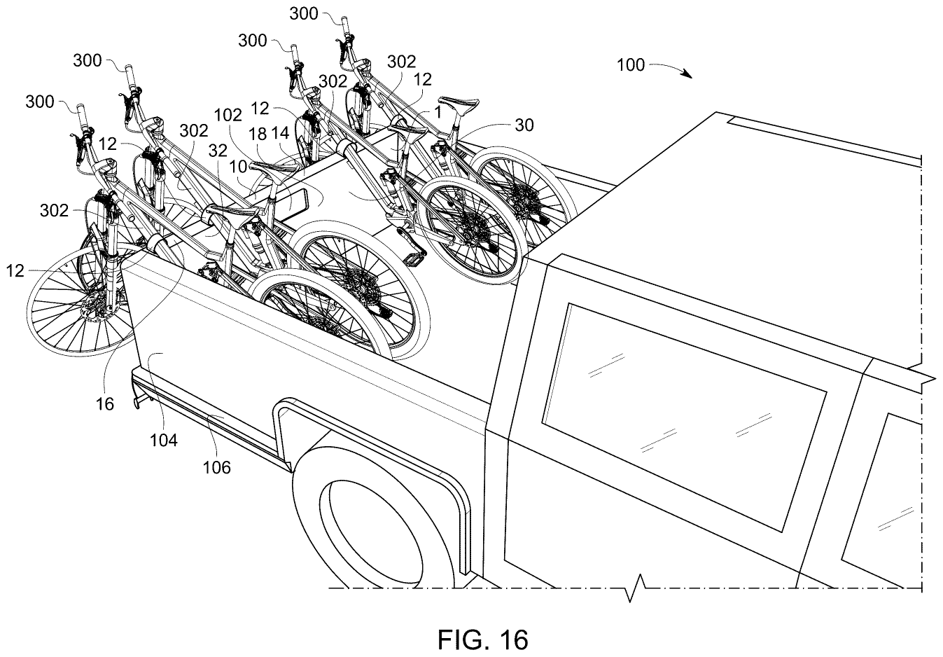

Section 10, which may be a 2^{nd} padded section of convertible tailgate storage pad 1, may be joined on one end to section 2 and joined on another end to a section 18, as mentioned, and shown close-up in FIG. 2. Section 10 may contain several (e.g., one, two, three, four, five, six, seven, or more) of straps 12, each of which may be a nylon (or similar material) strap that is passed through a loop (e.g., a plastic ring or nylon loop) then securely fastened back onto itself by hook and loop fasteners, slide buckles, or by another attachment mechanism, or combination of attachment mechanisms, forming an openable loop, as shown in FIGS. 7 and 8. Straps 12 may be used to firmly secure one or more of bicycles 300 to convertible tailgate storage pad 1, as shown in FIGS. 15 and 16.

Straps 12 may be present on a bottom or inner side of section 10 when sections 2 and 18 are folded against each other as shown in FIG. 1 and close-up in FIG. 2. In this configuration straps 12 may be concealed between sections 2 and 18 and not usable. When convertible tailgate storage pad 1 is first unfolded then folded backward, so that section 10 and section 18 may be rotated at an almost 360 degree angle relative to the section 2, as shown in transition in FIG. 6, so that section 10 is now resting on a top side or end of tailgate 102 and section 18 is now resting against an interior side (e.g., a side facing bed 104) of tailgate 102, straps 12 may now be present on an upper or outer side of section 10, as shown in FIGS. 7 and 8. With straps 12 positioned on a top side or end of tailgate 102 to which convertible tailgate storage pad 1 may be attached, each of straps 12 may be able to firmly hold one of bicycles 300 by strapping each of frames 302, which may be a down tube or frame section of each of bicycles 300, through one of straps 12, keeping each of bicycles 300 upright, firmly straddling tailgate 102, with the front tire and fork of each of bicycles 300 on an exterior side of tailgate 102, while the rest of each of bicycles 300 sits above tailgate 102 and/or inside bed 104 of truck 100, as shown in FIGS. 15 and 16.

This configuration may allow one or more of bicycles 300 to be transported using bed 104 of a truck 100, protecting truck 100 from the each of bicycles 300, protecting each of bicycles 300 from truck 100, and protecting each of bicycles 300 from one another, if more than one bicycle 300 is attached. In this configuration, convertible tailgate storage pad 1 is converted for bicycle transportation, and if truck 102 is equipped with a truck cap, topper, or camper shell, or equipped with a hard or soft tonneau cover, the cap, topper, or shell's rear door, or tonneau cover's rear end may need to be left open because one or more of bicycles 300, if present, may prevent the doors or ends from closing. If no bicycle 300 is present, section 10 of convertible tailgate storage pad 1 on top of tailgate 102 may still be too thick to allow proper closing of a rear door or cover end.

If convertible tailgate storage pad 1 is not currently transporting one or more of bicycles 300, however, it may be quickly and easily be converted for exterior storage, as shown in transition in FIG. 6 and shown transitioned in FIG. 1, where no padded sections (i.e., only straps) may be present on a top side or end of tailgate 102, allowing any rear doors or cover ends of truck caps, toppers, camper shells or tonneau covers to be properly closed, if truck 100 is so equipped, as mentioned previously. Section 10 may further be divided into sub-sections 14 and 16, each of which is joined to a corresponding sub-section of section 18, as shown in FIGS. 6, 7, 8, 9, 10, and 11, so that only a portion or portions of convertible tailgate storage pad 1 may be converted for bicycle transportation while another portion or portions remain configured for exterior storage, as further described below.

Section 18, which may be a 3^{rd} padded section of convertible tailgate storage pad 1, may be joined on one end to section 10 and may be detachably connected on another end to section 2, as mentioned and shown in FIG. 1. As also shown in FIG. 1, section 18 may contain webbing 24, which may be made of nylon or a similar material, that may be configured as rows and/or columns of webbing to create a MOLLE-type attachment system. Each row and/or column of webbing 24 may have alternating sections of open or looped sections and closed or stitched sections, as shown in FIG. 1 and close-up in FIG. 2.

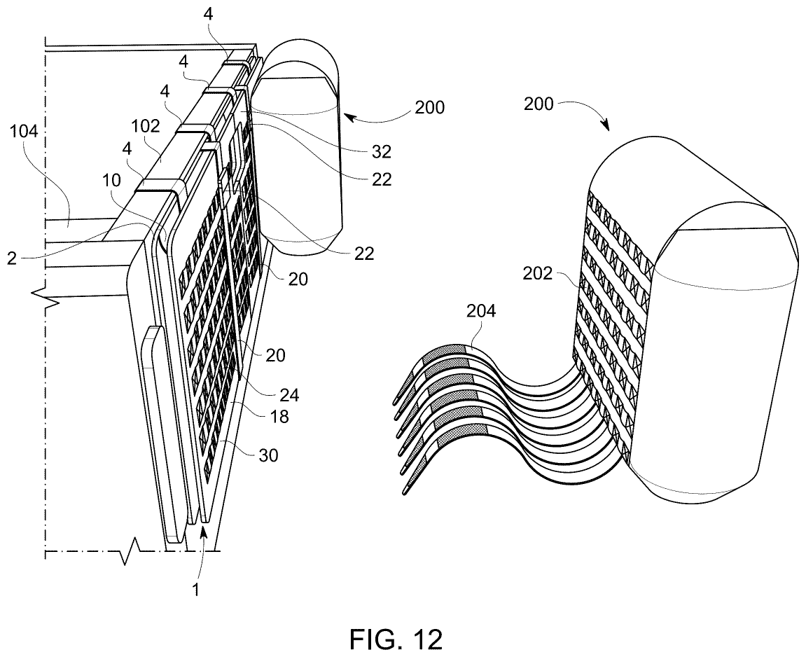

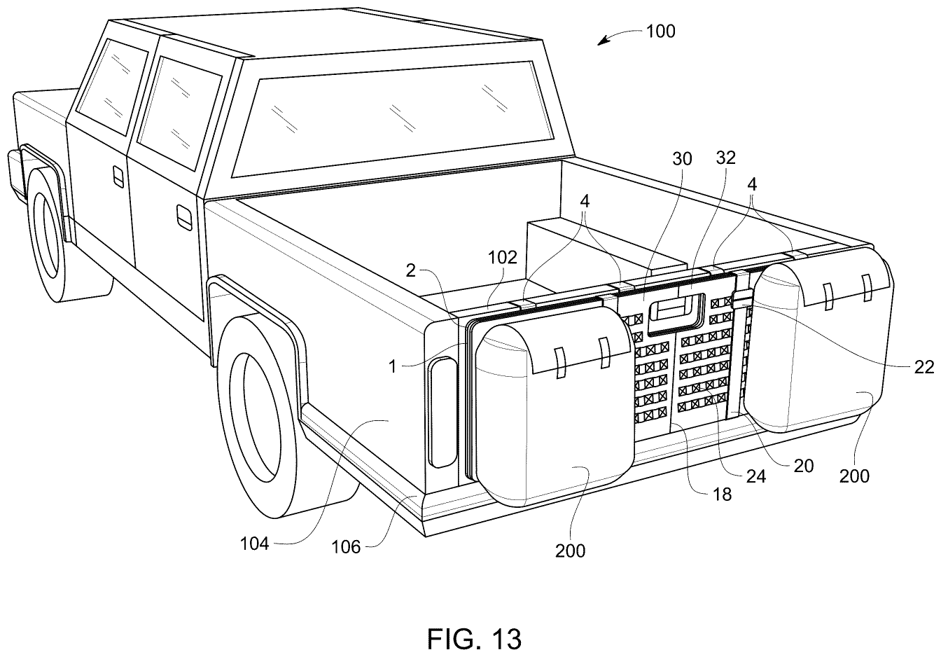

As shown in FIGS. 12 and 13, webbing 24 may be used to attach exemplary bags 200, which may be MOLLE bags, cases, or accessories that may contain webbing 202, which may be MOLLE-type webbing of rows and/or columns, similar to webbing 24 of section 18 of convertible tailgate storage pad 1, which may be used to detachably connect each of bags 200 to section 18, by interweaving all or some of straps 204 on each of bags 200, through webbings 24 and 202, alternating between rows and/or columns on section 18 and each of bags 200 to form a tight fit between each of bags 200 and convertible tailgate storage pad 1, (e.g., as shown with one bag in transition of being attached and one bag attached in FIG. 12 and two of bags 200 attached in FIG. 13); Or certain items, such as fishing poles, recovery traction boards, fire extinguishers, flash lights, tools, other gear and items, or other non-MOLLE bags and cases may secured directly to the webbing 24 of section 18 of convertible tailgate storage pad 1 by use of straps, buckles, hook and loop fasteners, clips, carabiners, zip ties, rope, string, or other attachment mechanisms and methods or a combination of mechanisms and methods. As shown in FIG. 1, section 18 may also contain buckles 22, which may be buckles, buckles and/or straps, and/or other attachment mechanisms that may detachably connect to one of straps 20 on section 2, allowing section 2 and section 18 to be detachably connected to each other on an exterior side of tailgate 102 of truck 100, to configure convertible tailgate storage pad 1 for exterior storage.

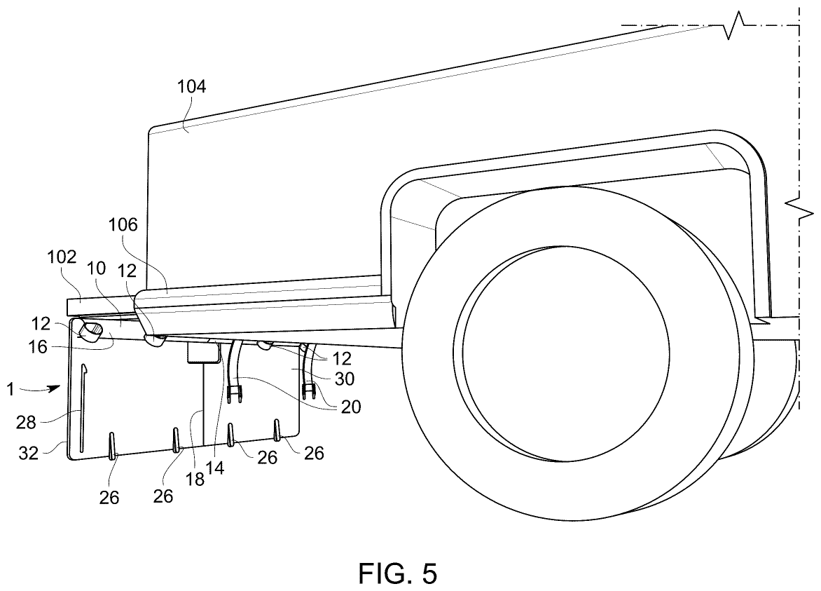

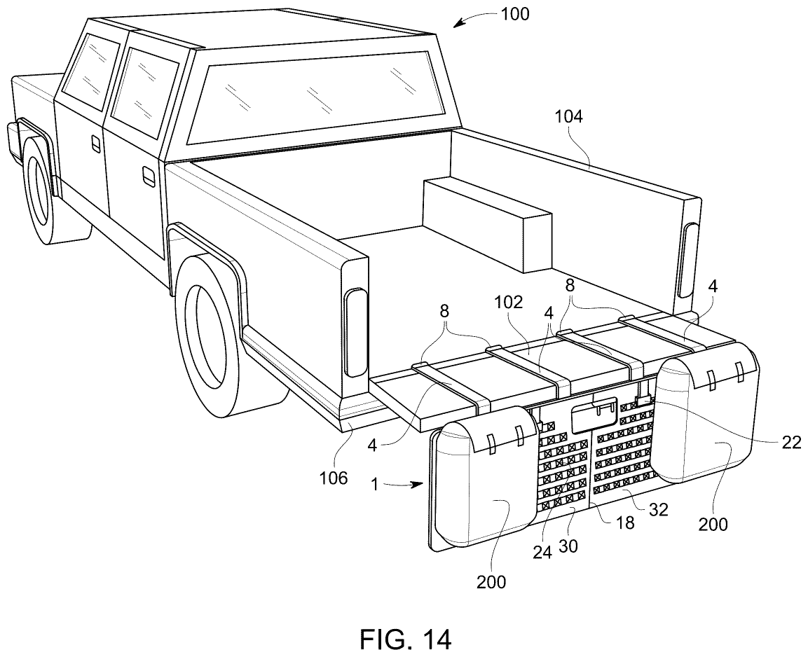

As shown in FIG. 1, when convertible tailgate storage pad 1 is configured for exterior storage, webbing 24 will be on an exterior facing side (i.e., a side facing away from tailgate 102) of section 18. This will allow bags 200 or other items to be stored on an exterior facing side of tailgate 102, as shown in FIG. 13. Some stored items may be too bulky to allow tailgate 102 to fully open when they're attached because, as shown in FIGS. 4 and 5, tailgate 102 may only have a small amount of clearance above bumper 106 of truck 102, when it's opened and partially or fully lowered. To allow unobstructed movement of tailgate 102, if necessary, with or without items stored on webbing 24 on an exterior side of section 18 of convertible tailgate storage pad 1, section 18 may be partially and temporarily detached from the section 2 (e.g., unbuckled or unlatched) by detaching each of straps 20 on section 2 from each of buckles 22 on section 18 to allow section 18 to pivot away from section 2 and tailgate 102, as shown in FIGS. 4 and 5, as tailgate 102 is in transition of being opened or closed or when fully open. This will also allow stored items such as bags 200 stored on webbing 24 of section 18 to be kept upright, while tailgate 102 is in transition of being opened or closed or when fully open, as shown in FIG. 14. This will prevent or minimize leaks from containers with liquid (e.g., bags 200 containing liquid waste or water containers) and it may also keep items, such as bags 200, with access from the top (e.g., top lids) still easily accessible with tailgate 102 up or down, as shown in FIGS. 13 and 14.

Buckles 22 on section 18 may also be unbuckled or unlatched or detached from straps 20 on section 2 to allow sections 10 and 18, which may be joined to each other, to be flipped over tailgate 102 of truck 100 (e.g., rotated at an almost 360-degree angle relative to section 2 and tailgate 102), shown in transition in FIG. 6, to convert convertible tailgate storage pad 1 for bicycle transportation, as shown in FIGS. 7 and 8. Section 18 may further contain straps 26, each of which may be small nylon (or similar material) straps with hook and loop fasteners and/or other attachment mechanisms present on a side of section 18 opposite of the side of section 18 that contains webbing 24 (e.g., on an inward facing side or side of section 18 facing tailgate 102 when convertible tailgate storage pad 1 is configured for exterior storage, as shown in FIG. 1, or more visible in FIG. 5, or on a side of section 18 facing an interior side of bed 104 when convertible tailgate storage pad 1 is converted for bicycle transportation, as shown in FIG. 8) that may be looped around each of loops 8 on straps 4 of section 2, on an interior side of tailgate 102, facing bed 104, of truck 100, to which convertible tailgate storage pad 1 is attached, as shown in FIG. 8.

When section 18 (along with section 10) is flipped over to convert convertible tailgate storage pad 1 for bicycle transportation, each of straps 26 on section 18 may be passed through each of corresponding loops 8 on straps 4 of section 2 on the side of the tailgate 102 that faces bed 104, as shown in FIG. 8. This may allow section 18 and, with it, section 10 to be firmly attached to and over tailgate 102 (e.g., so that they're not loose during transit). In this configuration, with any stored items secured to webbing 24 on section 18 removed, if necessary, and section 10 now resting on a top side or end of tailgate 102 while section 18 rests against an interior side of tailgate 102 that faces bed 104 of truck 100 (e.g., the side with webbing 24 will now be facing the interior side of tailgate 102 and straps 26 on the opposite side will be facing the interior of bed 104), one or more of bicycles 300 may be secured to each of straps 12 on section 10, as shown in FIGS. 15 and 16.

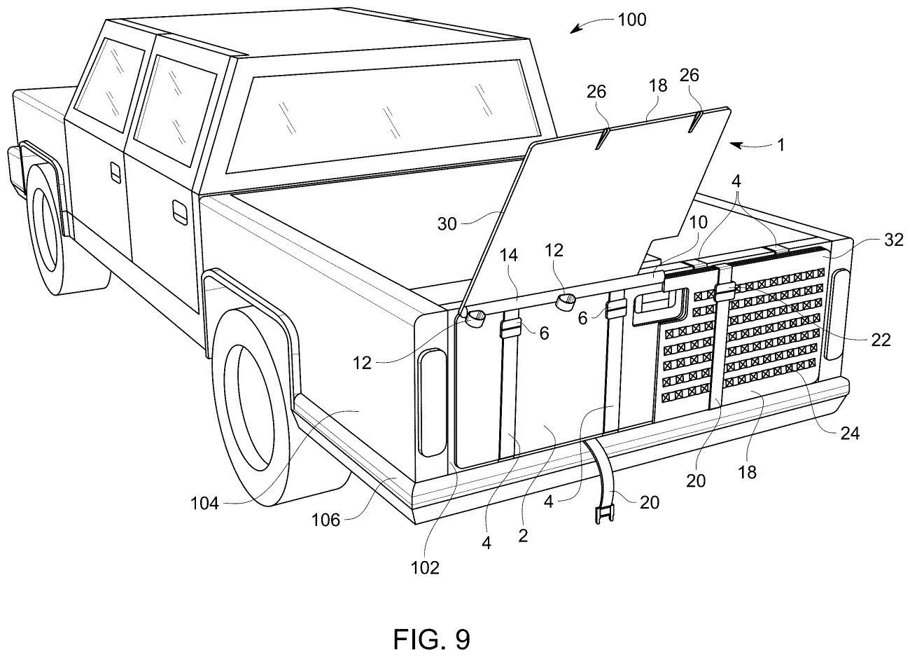

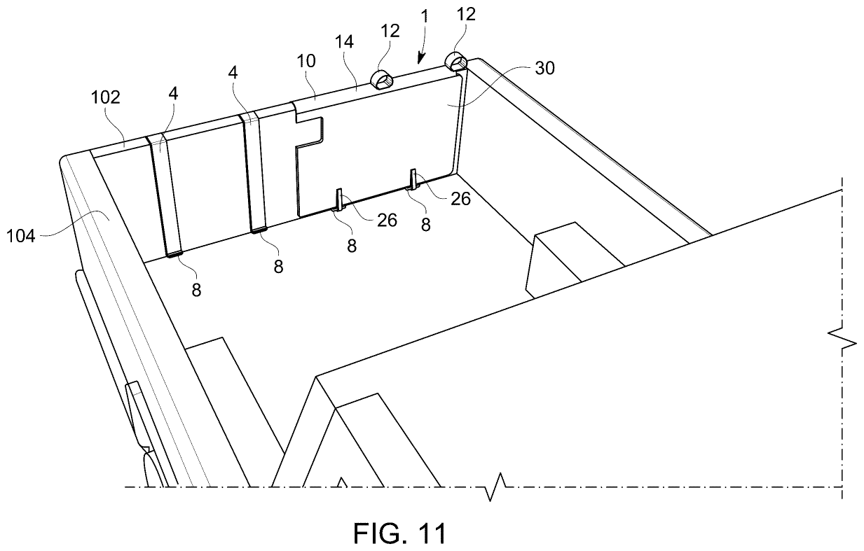

The section 18 may be divided into sub-sections 30 and 32 that may joined to corresponding sub-sections 14 and 16, respectively, of section 10 to allow a portion or portions of convertible tailgate storage pad 1 to be converted for bicycle storage while another portion or portions remains configured for exterior storage, as shown in transition in FIG. 9 and transitioned in FIGS. 10 and 11. If sections 10 and 18 are each further divided as described, then only certain portions may be unbuckled or unlatched from section 2, by detaching each of straps 20 on section 2 from one of buckles 22 on section 18 that secures that portion or portions of section 18 to be flipped over tailgate 102, as shown in transition in FIG. 9 and transitioned in FIG. 10, to be secured by each of straps 26 on section 18 that may be present on the interior side of tailgate 102 facing bed 104 to one of loops 8 of section 2, as shown in FIG. 11.

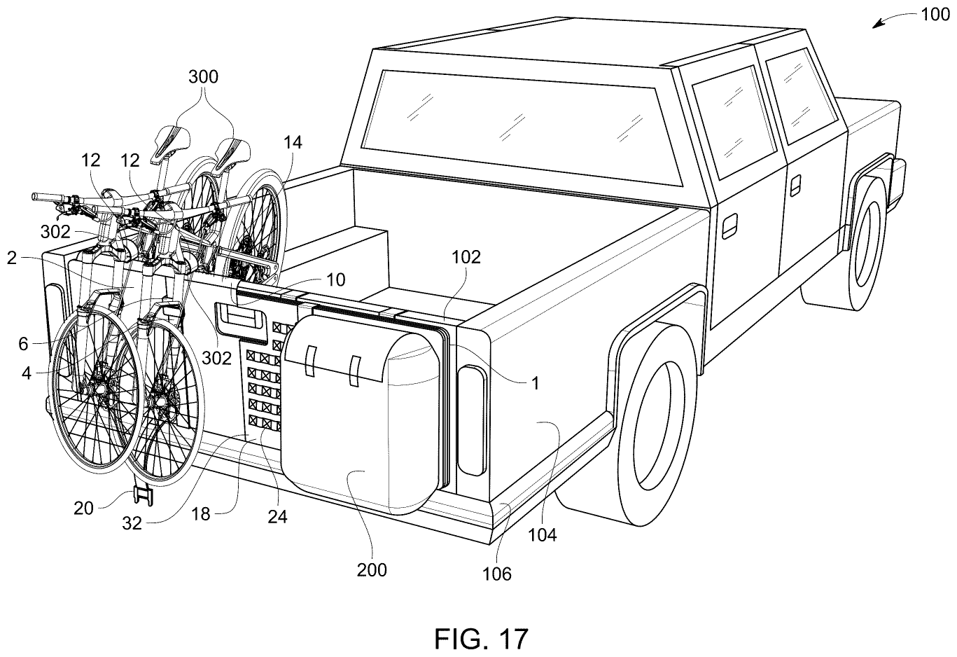

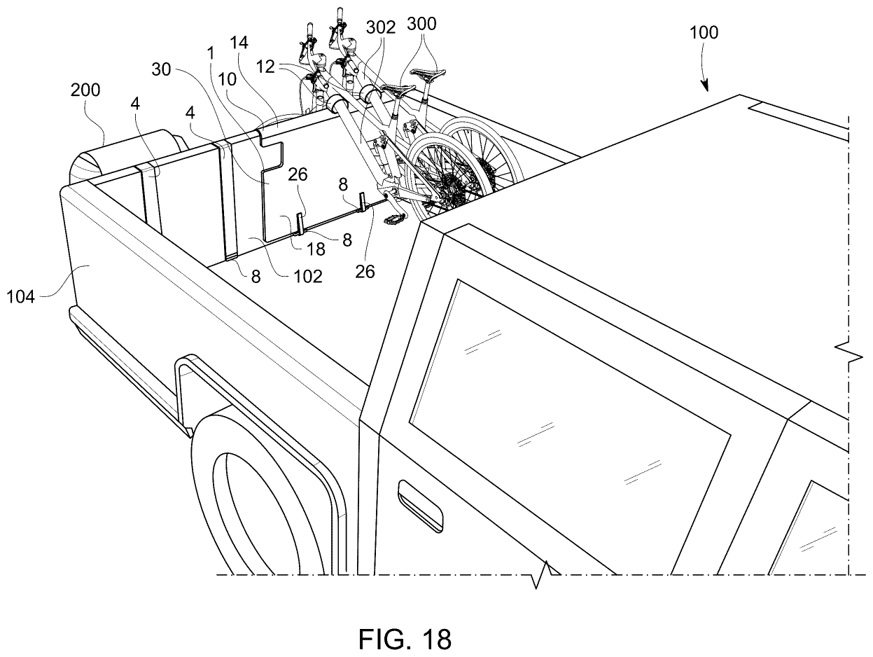

An exemplary configuration of convertible tailgate storage pad 1 shows sub-section 14 of section 10 joined to sub-section 30 of section 18 which is detached from section 2 configured to transport one or more of bicycles 300, with a portion of each of bicycles 300 on an exterior side of tailgate 102, above or on a top side or end of tailgate 102, and inside bed 104 of truck 100; while sub-section 16 of section 10 joined to sub-section 32 of section 18 which is attached to section 2 is configured to store bag 200 on an exterior side of tailgate 102 of truck 100, as shown in FIGS. 17 and 18.

What is claimed is:

1. A vehicle padding system comprising:
a connection pad comprising a connector that is configured to secure an object to the vehicle padding system;
a tailgate pad configured to be attached to an exterior side of a tailgate of a vehicle; and
a joint between the connection pad and the tailgate pad,
wherein the connection pad is configured to flip via the joint over the tailgate.

2. The vehicle padding system of claim 1, wherein the connector comprises:
a MOLLE webbing,
a strap with a fastener; or
a combination thereof.

3. The vehicle padding system of claim 1, wherein the joint comprises an anchor that is configured to attach to a frame of an object.

4. The vehicle padding system of claim 3, wherein the anchor is configured to surround a portion of the frame of a bicycle.

5. The vehicle padding system of claim 1, wherein the connection pad comprises a first portion that is flippable over the tailgate via a first portion of the joint; and a second portion that is flippable over the tailgate via a second portion of the joint.

6. The vehicle padding system of claim 5, wherein the joint comprises an anchor configured to attach to a frame of an object.

7. The vehicle padding system of claim 1, further comprising a strap to attach the vehicle padding system to the tailgate.

8. The vehicle padding system of claim 1, wherein when the connection pad flips over the tailgate via the joint, the joint covers a top of the tailgate.

9. A vehicle padding system comprising:
a connection pad configured to connect to a connector that is configured to secure an object to the vehicle padding system;
a tailgate pad configured to be attached to a tailgate of a vehicle; and
a joint between the connection pad and the tailgate pad, the joint comprising an anchor that is configured to attach to a frame of a bicycle,
wherein the connection pad is configured to flip over the tailgate via the joint, allowing the joint to cover a top of the tailgate.

10. The vehicle padding system of claim 9, wherein the anchor is configured to surround a portion of the frame of the bicycle.

11. The vehicle padding system of claim 10, wherein the connection interface comprises a hook and loop connection.

12. The vehicle padding system of claim 9, wherein the connector comprises:
a MOLLE webbing,
a strap with a fastener; or
a combination thereof.

13. The vehicle padding system of claim 9, wherein the connection pad comprises a first portion that is flippable over the tailgate via a first portion of the joint; and a second portion that is flippable over the tailgate via a second portion of the joint.

14. The vehicle padding system of claim 9, further comprising a strap to attach the vehicle padding system to the tailgate.

15. A vehicle padding system comprising:
a connection pad comprising:
a connector that is configured to secure an object to the vehicle padding system,
a first portion and a second portion;
a tailgate pad configured to be attached to a tailgate of a vehicle; and
a joint between the connection pad and the tailgate pad,
wherein the connection pad comprises a first portion that is flippable over the tailgate via a first portion of the joint; and a second portion that is flippable over the tailgate via a second portion of the joint.

16. The vehicle padding system of claim 15, wherein the joint comprises an anchor that is configured to attach to a frame of an object.

17. The vehicle padding system of claim 16, wherein the anchor is configured to surround a portion of the frame of a bicycle.

18. The vehicle padding system of claim 15, wherein the connector comprises:
a MOLLE webbing,
a strap with a fastener; or
a combination thereof.

19. The vehicle padding system of claim 15, further comprising a strap to attach the vehicle padding system to the tailgate.

20. The vehicle padding system of claim 15, wherein when the first portion of the connection pad flips over the tailgate via the first portion of the joint, or the second portion of the connection pad flips over the tailgate via the second portion of the joint, the first portion of the joint or the second portion of the joint covers the top of the tailgate.
